(19) United States
(12) Patent Application Publication
(10) Pub. No.: US 2026/0360090 A1
(43) Pub. Date: Nov. 12, 2026

(54) REDUCTION OF IMAGE ARTIFACTS IN VIRTUAL AND EXTENDED REALITY SYSTEMS

(71) Applicant: GOOGLE LLC, Mountain View, CA (US)

(72) Inventors: Philip George Nichols Lamoureux, San Francisco, CA (US); Tim Kunwoo Kwak, Irvine, CA (US); Hendrik Wagenaar, Santa Clara, CA (US)

(21) Appl. No.: 19/203,035

(22) Filed: May 8, 2025

(51) Int. Cl. G06T 19/00; G06F 3/01

(52) U.S. Cl. CPC G06T 19/006; G06F 3/012

(57) ABSTRACT

Techniques are directed to modifying an orientation of a user's head by an angle (e.g., 45 degrees) to produce a modified orientation; this modified orientation is then used to render a scene to be displayed in the virtual environment, prior to display. It should be noted that this modification of the head orientation does not involve the user actually modifying their head pose but rather modifying the data representing the orientation. It is with this modified orientation that drives the virtual camera by which the VR application system generates an image of an object, e.g., defines a perspective from which the object is viewed in the image. At display time, however, the VR system rotates the image back to the perspective of the original head pose (e.g., rotates the image −45 degrees).

### BACKGROUND

Virtual reality (VR) and/or extended reality (XR) devices provide virtual environments for applications in which a user can be immersed. VR and/or XR devices make use of a virtual camera for rendering virtual scenes that move with the user's head.

### SUMMARY

Implementations described herein relate to reducing image artifacts (e.g., defects) in computing devices such as VR and XR devices. Such computing devices can have high-resolution displays that have a large number of pixels. Because the displays are placed directly in front of the user's eye and cover the entire field of view of the user, the effective computing device resolution is relatively low in terms of pixels per area (e.g., degree). This relatively low effective resolution can cause noticeable image artifacts due to this low effective resolution. These imperfections are especially pronounced on objects having high contrast lines that are rendered at angles with small offsets from the horizontal or vertical. Nevertheless, rendering an image of an object using a virtual camera oriented at an angle from a detected orientation of the head can substantially reduce these artifacts. At display time, however, the computing device performs a rotation operation on the image to render the image using the virtual camera oriented at the original head orientation (e.g., rotates the image by −45 degrees). In this way, the artifacts, even for lines slightly offset from the horizontal or vertical, can be substantially reduced in size.

In one general aspect, a method can include determining a first orientation of a head of a user in a physical environment. The method can also include receiving a first image of an object based on a second orientation, the second orientation being different from the first orientation. The method can further include modifying, based on the first orientation, the first image to produce a second image of the object. The method can further include displaying the second image of the object.

In another general aspect, an apparatus can include memory and a processor coupled to the memory. The processor can be configured to determine a first orientation of a head of a user in a physical environment. The processor can also be configured to receive a first image of an object based on a second orientation, the second orientation being different from the first orientation. The processor can further be configured to modify, based on the first orientation, the first image to produce a second image of the object. The processor can further be configured to display the second image of the object.

In another general aspect, a computer program product comprising a nontransitory storage medium, the computer program product including code that, when executed by a processor, causes the processor to perform a method. The method can include determining a first orientation of a head of a user in a physical environment. The method can also include receiving a first image of an object based on a second orientation, the second orientation being different from the first orientation. The method can further include modifying, based on the first orientation, the first image to produce a second image of the object. The method can further include displaying the second image of the object.

The details of one or more implementations are set forth in the accompanying drawings and the description below. Other features will be apparent from the description and drawings, and from the claims.

### BRIEF DESCRIPTION OF THE DRAWINGS

FIG. 1A is a third person view of an example physical environment in which a user is experiencing a computing device through a display of a head worn device.

FIG. 1B is a diagram illustrating an example viewing of artifacts in a computing device, according to an aspect.

FIG. 1C is a diagram illustrating an example image of a feature with a line slightly offset from the horizontal without modification, according to an aspect.

FIG. 1D is a diagram illustrating an example image of a feature with a line slightly offset from the horizontal with modification, according to an aspect.

FIG. 2A is a diagram illustrating an example head of a user with a computing device with a symmetric field of view and a modification of the orientation of the head, according to an aspect.

FIG. 2B is a diagram illustrating an example head of a user with a computing device with an asymmetric field of view and a modification of the orientation of the head, according to an aspect.

FIG. 2C is a flow chart illustrating an example process of generating an image for a computing device that has reduced artifacts.

FIG. 2D is a flow chart illustrating an example process of generating an image for a computing device that has reduced artifacts.

FIG. 3A is a diagram illustrating an example head of a user with a device and a modification of the orientation of the head, according to an aspect.

FIG. 3B is a diagram illustrating an example process of generating image frames for a computing device that has reduced artifacts.

FIG. 4 is a diagram illustrating an example electronic environment in which the above-described reduction of artifacts in computing system images may be performed, according to an aspect.

FIG. 5 is a flow chart illustrating an example process of reducing artifacts in computing system images, according to an aspect.

### DETAILED DESCRIPTION

Computing systems such as virtual reality (VR) systems and/or extended reality (XR) systems provide a virtual environment for applications in which a user can be immersed. Such computing systems employ near-eye displays built into a head-worn display and pose (orientation) imaging to provide the user with that immersive feel in the virtual environment. This disclosure is directed to an improvement for generating an image for a near-eye display in a computing system (e.g., VR and/or XR) that has been modified to reduce or eliminate artifacts in the image. Specifically, images can be rotated (e.g., rotated 45 degrees) when being rendered. In this way, any lines near the horizontal or vertical that would have large artifacts are rendered as diagonal lines with small artifacts. This image may then be rotated back to its original perspective via rotation and reprojection; this rotation and reprojection can also reduce artifacts in other lines in the image. In this way, the artifacts can be reduced to the point where they are no longer distracting to the user.

At least reason for implementing the concepts described herein is that near-eye displays tend to make pixels appear larger to the user even using high-definition displays. Accordingly, the images presented to the user can appear to have unwanted artifacts due to the large pixels. These artifacts, if sufficiently prominent, can be distracting to the user. The severity of the artifacts depends on the direction of lines in an image. For example, lines that are a few degrees away from a horizontal or vertical axis tend to have the largest artifacts, while diagonal lines at or near 45 degrees from the horizontal or vertical tend to have the smallest artifacts. For example, a three-dimensional table in a virtual environment can appear as a rectangle with lines that make slight angles with a coordinate axis; such a table may exhibit large, distracting artifacts to the user.

An orientation is defined as a rotation in a viewing plane (e.g., normal to an eye) in three-dimensional (3D) space. Such a direction can be defined by a triplet of angles, e.g., a yaw, a pitch, and a roll. These angles can define the position of a head of a user wearing a head-worn device of a computing system. The angles may be defined with respect to a coordinate system, e.g., a viewing plane of the user. In some implementations, however, the orientation may be defined as a single angle corresponding to the roll. For example, the orientation imaging may be accomplished using gyroscopes and motion sensors; these may also be used for imaging body and hand positions.

Computing systems can be configured to provide the virtual environment in which the user is immersed. To provide this virtual environment, a computing system has a processor coupled to memory; in some implementations, the processor is built into the head-worn device. In some implementations, however, the computing system uses a processor that is separate from the head-worn device, e.g., in a computer or smartphone connected to the head-worn device. When the processor is on the head-worn device, the processor is smaller and hence the computing resources may be scarcer than on a smartphone or computer.

It should be noted that, while the stereoscopic display of a computing system is high-definition and accordingly has a high number of pixels, the display is positioned very close to the user's eyes, e.g., 5-8 cm, and cover the user's entire field of view. This positioning of the display so close to the user's eyes stands in contrast to usual viewing distances of 1-2 m for a smartphone or television. Accordingly, when measured in pixels per degree, the resolution of a computing system may be lower than it would for, e.g., a smartphone or a television.

While computing systems provide the virtual environment for the user, the graphics that fill in the virtual environment with virtual objects are provided by a computing application system. Such an application system can provide computing applications such as video games, 3D cinema, and virtual theme parks. The application system is thus configured to render synthetic scenes, e.g., image frames seen from various perspectives through a virtual camera, in the virtual environment. The application system runs, in some implementations, on the processor in the head-worn device. In some implementations, however, the application system runs on a separate processor from the computing system.

A computing system, in concert with an application system, can render images in the virtual environment as follows. First, the computing system detects the orientation of the head in a physical environment, e.g., in the real world and not in the virtual environment. The head pose is a number representing an angle; the computing system transmits data representing this orientation to the application system. The application system renders an image of an object, e.g., an object in a scene, using the orientation to define a virtual camera. The object is thus viewed from the perspective of the virtual camera, defined by the orientation of the user's head. The application system then sends the image of the object from the perspective of the virtual camera to the computing system, which displays the image of the object in the display.

The near-eye displays include small, high-definition stereoscopic displays for displaying image frames, which can be displayed at a frame rate between 75 and 120 frames per second.

It is noted that a computing system can produce two video streams, one for each of the user's eyes. This produces the stereoscopic effect that enhances the immersive experience. That said, as the techniques described herein do not depend on the stereoscopic effect, the discussion below will reference a single image, orientation, and virtual camera.

A challenge with rendering images in a computing system involves latency. Latency is defined as a time interval between determining the orientation of the user's head in the physical environment and displaying the image on the display. An example of such a time interval is about 50 milliseconds although the latency can be different from this. Accordingly, during the latency the head orientation at display time may be significantly different than the originally determined orientation. Not addressing the latency in the image rendering steps can result in significant user discomfort. Accordingly, to address the latency, the computing system performs a prediction of the head orientation at display time when the computing system determines the head orientation in the physical environment. The prediction can be based on a model of human head movements through a latency, e.g., about 50 milliseconds; in some implementations, the model is a neural network model. In this case, the computing system, after forming a predicted orientation of the user's head at display time, transmits data representing the predicted orientation to the application system, which generates the image of the object from the perspective of a virtual camera oriented at the predicted orientation. In this way, user discomfort is reduced.

In some implementations, the computing system also performs a late stage reprojection of the image produced by the application system. This late stage reprojection is an additional rendering stage that addresses any possible unexpected head motion that may cause the orientation at display time to be different from the predicted orientation. Accordingly, after receiving the image of the object from the application system, the computing system updates the head orientation after receiving the image; at this point, there are about 5 milliseconds remaining until the image is displayed and further head movements will not be significant. The computing system then reprojects the image, e.g., the computing system pans and rotates the image to correct for any differences between the predicted orientation sent to the application system and the updated orientation. This reprojection can further reduce any user discomfort.

A technical problem with the above-described rendering of images by a computing system and application system is that the images exhibit artifacts. Artifacts in this context refer to visual imperfections resulting from representing objects in a pixelated two-dimensional (2D) image. For example, as stated above, although a computing system uses a high definition display with a large number of pixels, the display is situated close to the user's eyes and accordingly the effective resolution of the display is low. That is, the user may be able to see individual pixels so that the image is pixelated. The edges of the image therefore exhibit a jagged appearance as a result of the pixelated image. Accordingly, the artifacts are particularly noticeable for computing systems.

The effect of the artifacts can become distracting to the user due to the high frame rate of the computing system. For example, the virtual camera has continuous movements and renders images in the virtual environment as the user's head moves, the head never being fully stationary. This leads to more micromovements when rendering an image in a virtual environment. Such movements cause the individual pixelated images to “crawl” or “shimmer” when they are viewed as a moving sequence. Such crawling and shimmering can be distracting for a user.

There are some techniques to reduce the artifacts in a computing system image. One such technique renders an image at a higher resolution (e.g., 4x the number of pixels) and then scales back to the desired resolution. Nevertheless, given the limited computational resources of a computing system, such a technique may be too onerous. Another technique involves determining edge pixels, e.g., where there is a discontinuity in the image, e.g., at an edge of an object, and resampling those pixels. While such a technique is less computationally demanding than the previously described technique, this technique does not reduce artifacts unrelated to object geometry, e.g., on lines and edges in text or other graphics.

Disclosed implementations provide a technical solution to the problem of rendering and displaying images in a computing system with reduced artifacts that do not distract the user. This technical solution is based on the observation that artifacts are especially pronounced on objects having high contrast lines that are rendered at angles with small offsets from the horizontal or vertical, while lines rendered at diagonals (e.g., 45 degrees) with respect to the horizontal or vertical have much smaller artifacts. Accordingly, the technical solution involves modifying an orientation of a user's head by an angle (e.g., 45 degrees) to produce a modified orientation; this modified orientation is then used to render a scene to be displayed in the virtual environment, prior to display. It should be noted that this modification of the head orientation does not involve the user actually modifying their head pose but rather modifying the data representing the orientation. It is with this modified orientation that drives the virtual camera by which the application system generates an image of an object, e.g., defines a perspective from which the object is viewed in the image. At display time, however, the computing system rotates the image back to the perspective of the original head pose (e.g., rotates the image −45 degrees). The artifacts, even for lines slightly offset from the horizontal or vertical, are substantially reduced and accordingly the shimmering/crawling is minimized.

In some implementations, the modification of the head orientation is performed by the application system configured to render the image of the object. In some implementations, the rotation of the head pose is performed by the computing system.

It is noted that, in some implementations, the rotation on which the modified orientation is based differs from the (unmodified) orientation by a predetermined amount. This predetermined amount, in some implementations, may be based on an updating of the orientation of the user's head after receiving the image of the object from the application system.

A technical advantage of the above-described technical solution is that the technical solution represents an effective artifacts reduction technique that reduces the distracting effects of crawling and shimmering in the moving images at a very low computational cost. The technical solution thus stands out from other techniques in that the technical solution may be performed on a processor of a computing system with virtually no drain on resources and remains an effective artifact reduction approach independent of the geometry of the image being rendered.

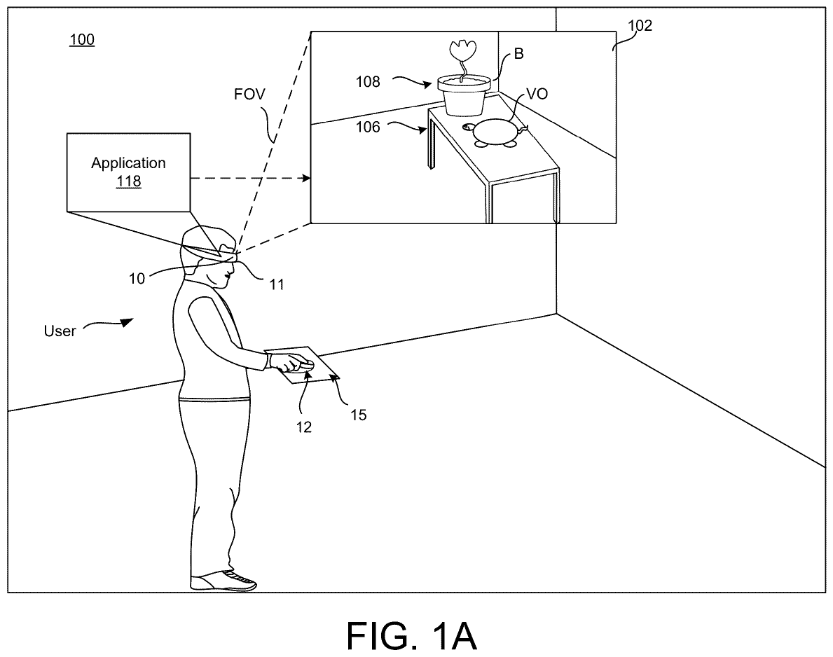

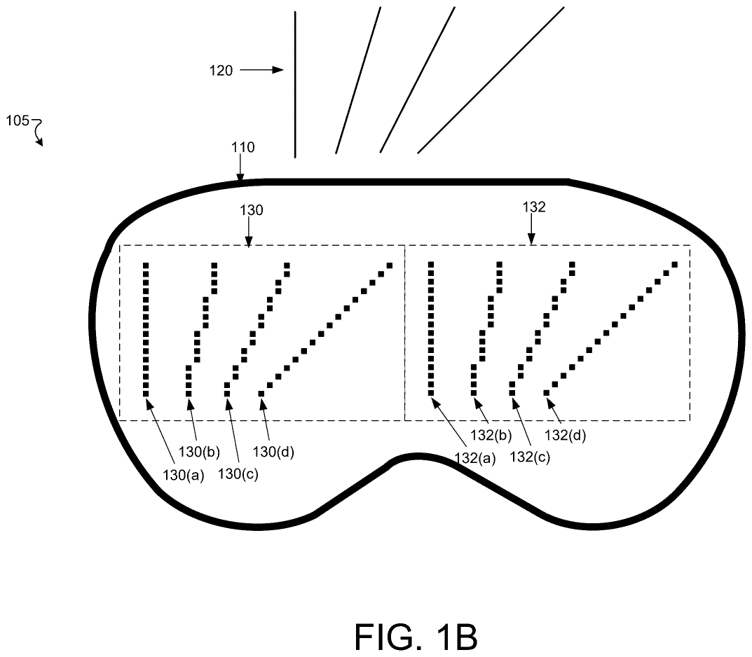

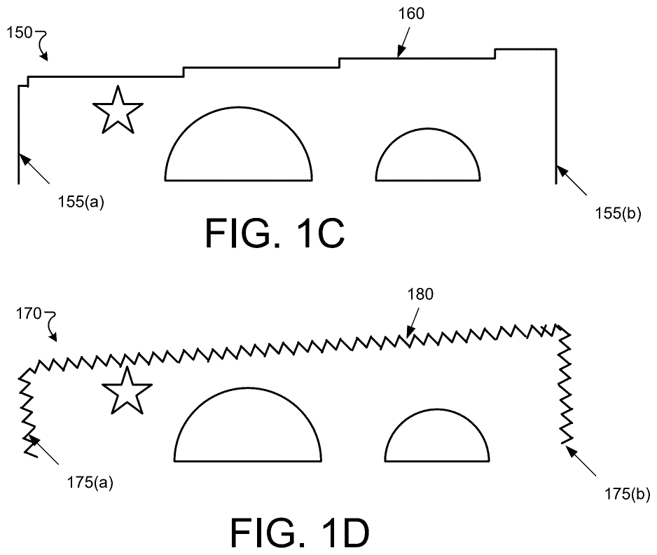

FIG. 1A is a third person view of an example physical environment 100 in which a user is experiencing a virtual environment 102 through a display 10 of a head-worn device 11 of a computing system such as a VR system and/or an XR system. Such a computing system is configured to generate an image for the display 10 and has been modified to reduce or eliminate artifacts in the image. Specifically, the computing system can rotate images (e.g., rotate by 45 degrees) when being rendered. In this way, any lines near the horizontal or vertical that would have large artifacts are rendered as diagonal lines with small or no artifacts. The computing system may then rotate the image back to its original perspective via rotation and reprojection; this rotation and reprojection can also reduce artifacts in other lines in the image. Accordingly, the computing system, as configured, can reduce artifacts to the point where the artifacts are no longer distracting to the user.

Because the head-worn device 11 has displays that are disposed close to the eyes, the pixels of any image displayed to the user may contain artifacts due to the large pixels. The size of the artifacts can depend on the orientation of lines in the image with respect to a horizontal or vertical axis. For example, lines that are angled slightly away from the horizontal or vertical axis tend to have the largest artifacts, while lines that are diagonal or close to the diagonal tend to have the smallest artifacts. Accordingly, at least one improvement involves generating images for the virtual environment 102 from orientations that have been modified by 45 degrees. In this way, one or more lines close to the horizontal or vertical axes are rendered as diagonal lines with smaller artifacts. The image may then be rotated back to the original orientation.

The virtual environment 102 (or an XR or VR environment) can be generated by instructions in the form of an application 118 (executed by an application system). The virtual environment 102 may be displayed to the user through the head-worn device 11, or other device (e.g., mobile device, laptop, etc.). The virtual environment 102 includes inserted virtual objects VO, B, 106, and 108 (e.g., content). In some implementations, the inserted virtual objects are displayed over an image of the physical environment 100 (which can be displayed within the display using a pass-through (e.g., outward facing) camera attached to the head worn device 11). In this example, the virtual object VO is a turtle on a representation of a table 106 near a representation of a flower 108 in the virtual environment 102.

Although this implementation is illustrated with the head-worn device 11, other types of devices can be used in conjunction with or instead of the head-worn device 11 such as a mobile phone, laptop computer, and/or so forth. In such implementations, the user could hold the device and can view the virtual environment through a display associated with (e.g., included in) the device.

As shown in FIG. 1A, the user is using an input device 12 (e.g., a 2D input device, a 2D navigation device) to navigate within the virtual environment 102. Specifically, the user is using the input device 12 to navigate within the virtual environment 102. The input device 12, in this implementation, is a 2D navigating device. In some implementations, the input device 12 is a device that is configured to make selections within and/or move within a 2D space 15 (e.g., 2D surface) represented by a plane. Said another way, the input device 12 can be configured to move an indicator (e.g., a visual symbol, a mouse cursor (or pointer)) on a computer display. It allows users to interact with elements on the screen, such as selecting objects (e.g., virtual, real-world) or files, clicking buttons, navigating web pages, and/or so forth.

The representation of the table 106 in the virtual environment 102 is rectangular but with the edges of the table 106 diverging at slight angles apart from each other due to the perspective. Accordingly, the edges define lines that deviate from a coordinate axis by a small amount (e.g., less than 15 degrees). As rendered directly by the virtual environment 102, the representation of the table 106 will have artifacts due to the large pixels viewed by the user in the display 10. A computing device in the head-worn device 11, however, can reduce the size of the artifacts by causing the application 118 to render the image at a different orientation and then reprojecting the image. The nature of the artifacts and their reduction in size are illustrated with regard to FIGS. 1B, 1C, and 1D.

FIG. 1B is a diagram illustrating an example viewing 105 of features 130 and 132 in a computing system 110 that exhibit artifacts. As shown in FIG. 1B, the computing system 110 takes the form of a head-worn device for the computing system) system, e.g., VR or XR goggles.

As shown in FIG. 1B, the computing system 110 is viewing an object in the form of a set of lines 120 that includes a set of lines positioned at various angles with respect to the vertical. For example, the leftmost line has a zero angle with respect to the vertical (e.g., a vertical line). The next line has an angle of about 14.0 degrees with respect to the vertical (e.g., Arctan[¼]). The line after that has an angle of about 26.6 degrees with respect to the vertical (Arctan[½]). The last line in the set is a diagonal line that is at 45 degrees with respect to the vertical.

The rendered images of the set of lines 120 are shown as features 130 and 132 in FIG. 1B exhibiting artifacts. Specifically, the vertical line is shown as images 130(a) and 132(a). The next line is shown as images 130Z(b) and 132(b). The following line is shown as images 130(c) and 132(c). The diagonal line is shown as images 130(d) and 132(d).

The images 130(a-d) and 132(a-d) are shown with relatively large pixels, represented by the black squares in FIG. 1B. The effect of the pixelation on the images is palpable. For example, while there are no artifacts due to pixelation of the images of the vertical line 130(a) and 132(a), there are significant artifacts in the images 130(b) and 132(b) of the slightly offset lines from the vertical.

For example, such artifacts can be measured as deviations from the original line in the set of lines 120 from the horizontal and the vertical. The maximum deviation of the images 130(b) and 132(b) normal to the original line is

$$\frac{4}{\sqrt{17}} \approx 0.97 pixels .$$

For the images 130(c) and 132(c), this deviation is

$$\frac{2}{\sqrt{5}} \approx 0.894 pixels .$$

For the images of the diagonal line 130(d) and 132(d), the deviation is

$$\frac{1}{\sqrt{2}} \approx 0.707 pixels .$$

It should be noted that, as the angle of the lines from the vertical are increased, the deviations are complementary, e.g., the angles are measured from the horizontal.

FIG. 1C is a diagram illustrating an example image of an object 150 with a line 160 slightly offset from the horizontal without modification. The vertical edges of the image 155(a) and 155(b) are not the same length so that the top line slightly deviates from the horizontal.

The resulting image of this line 160 as shown in FIG. 1C has artifacts as the line 160 has been pixelated. For example, if the grade of the slant of line 160 is ⅛, then the line 160 is nominally tilted at about 7.1 degrees from the horizontal. Nevertheless, the larger effect of the aliasing is that, as subsequent image frames are displayed, the artifacts—the pixelated deviations from a straight line—will move back and forth along the line 160 and create a crawling or shimmering effect that is distracting to the user. It is noted, however, that the vertical lines 155(a) and 155(b) do not have such artifacts.

FIG. 1D is a diagram illustrating an example image of an object 170 with a line 180 slightly offset from the horizontal with modification. The vertical edges of the image 175(a) and 175(b) are not the same length so that the top line slightly deviates from the horizontal.

The difference from the image of the object 150 in FIG. 1D is that in this case, before the image is rendered by an application system, the user head orientation is modified by an addition of 45 degrees to the detected or predicted orientation. That is, if the user's head were predicted to be oriented at 10 degrees about an axis normal to the user's body, then the application system would generate an image with virtual cameras at 55 degrees about that axis, e.g., a modification of the head orientation by 45 degrees. The computing system, upon receiving the image, modifies the image, e.g., via a rotation of the image by 45 degrees in the opposite direction about the axis, or −45 degrees. The computing system then displays the resulting image after modification.

The result of the modification of the head orientation and the subsequent image is shown in FIG. 1D. Instead of the large artifacts seen in FIG. 1C over line 160, there are much smaller artifacts shown along line 180. These artifacts are a result of the line 180, after modification of the orientation, being rendered as a near-diagonal line with effectively diagonal-sized artifacts. These artifacts are much smaller and closer together than those in FIG. 1C with respect to line 160. Accordingly, the crawling and shimmering effect as subsequent frames are displayed is much smaller to the point of being negligible.

It is noted that the vertical lines 175(a) and 175(b) have similar artifacts as the line 180, while the vertical lines 155(a) and 155(b) in FIG. 1C do not have any such artifacts. The reason for this is because the orientation by which the virtual cameras for a perspective on the generated image changed by 45 degrees, and the vertical lines 175(a) and 175(b) became diagonal lines. Accordingly, the lines 175(a) and 175(b) formed artifacts for diagonal lines which remained upon rotation of the image by the computing system prior to display.

For images with diagonal lines, however, a modification of the head orientation by 45 degrees may convert such lines into horizontal or vertical lines. When the lines are perfectly diagonal, then, there will be no artifacts introduced. If the lines are slightly deviant from a diagonal, then the result will be the lines having a slight deviation from a horizontal or vertical, which would introduce large artifacts. Such artifacts, however, may be reduced in the subsequent modification of the image by the computing system prior to display.

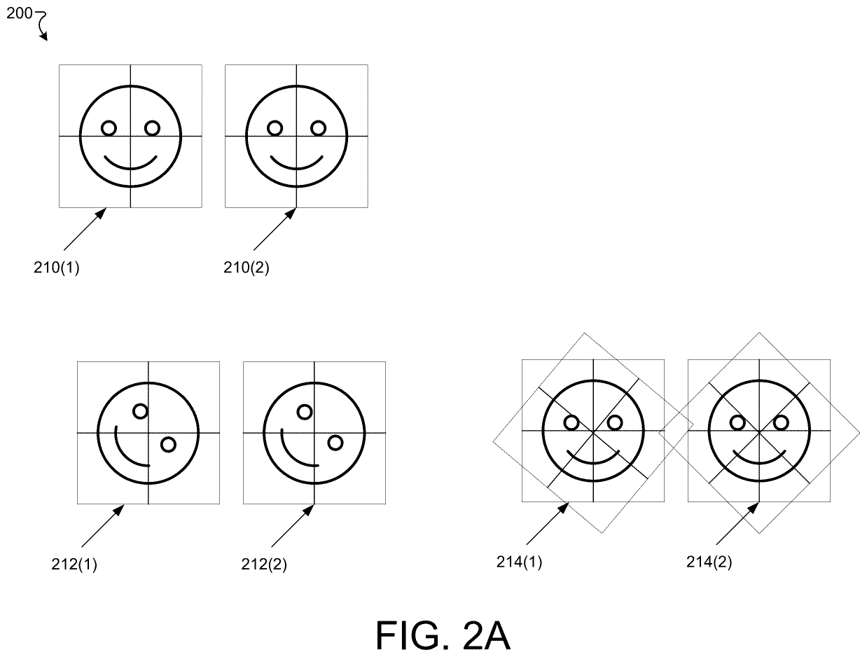

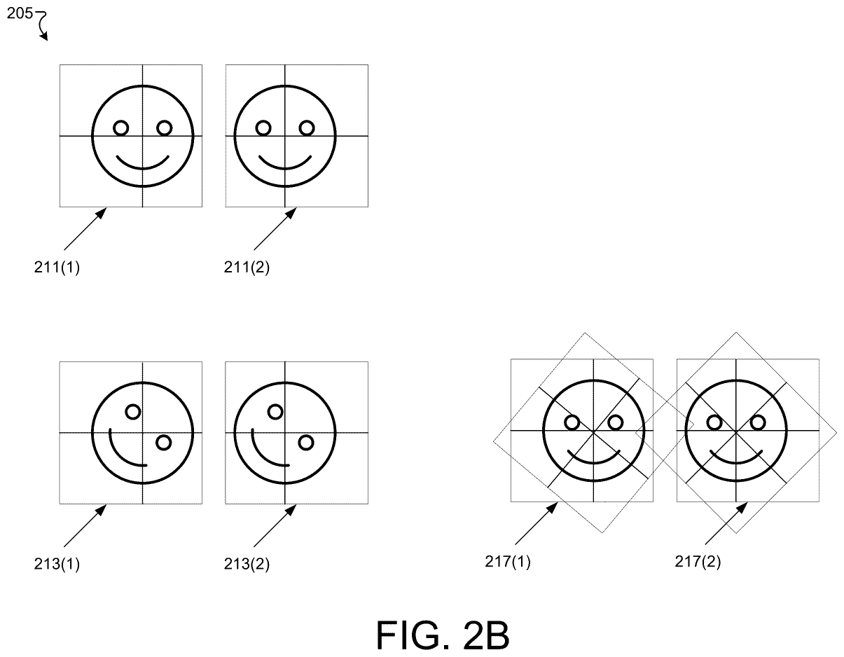

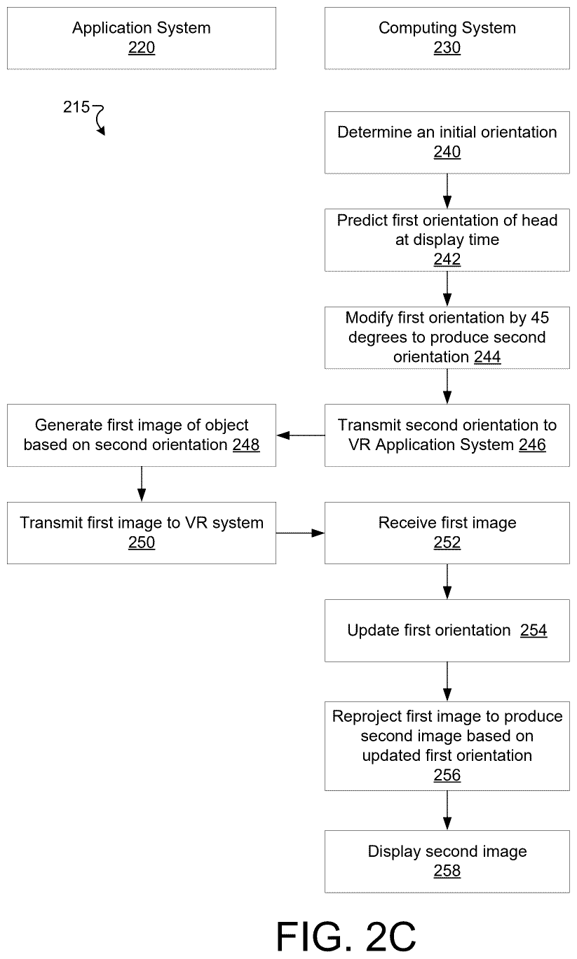

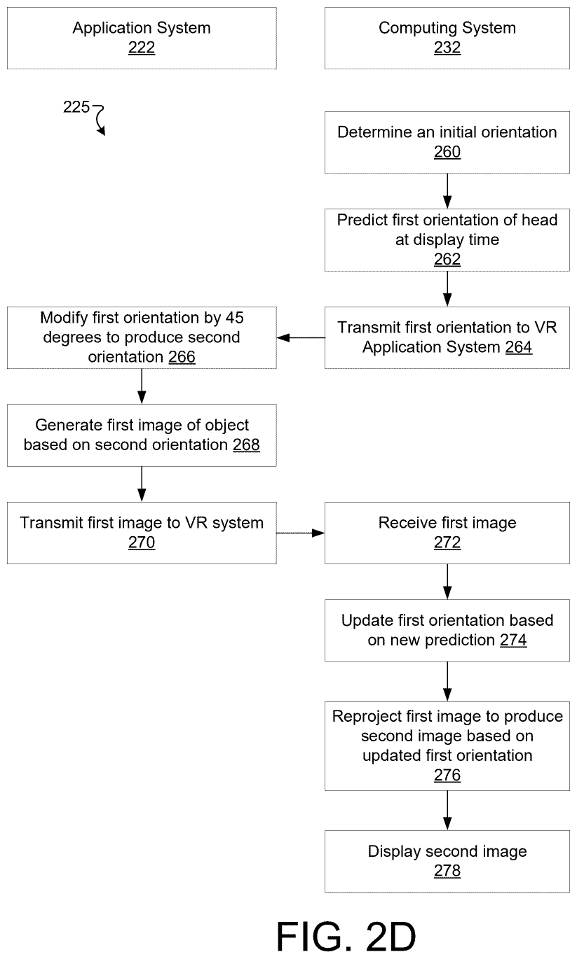

FIG. 2A is a diagram illustrating an example scenario 200 involving a left image 210(1) seen by a left eye of a user and a right image 210(2) seen by a right eye of the user of an object in a head-worn device. The images 210(1) and 210(2) are shown in a symmetric field of view (FOV) with the object at a zero degree orientation.

As part of the image rendering process, the orientation of the user's eyes are modified so that there is an effective change in orientation of the eyes by 45 degrees so that left image 212(1) and right image 212(2) show the object at a 45 degree orientation with respect to an axis normal to the viewing plane. The user does not actually turn their head into this orientation, but rather the modified orientation is transmitted to an application server. In some implementations, the application system renders to a larger field of view to account for non-symmetric fields of view.

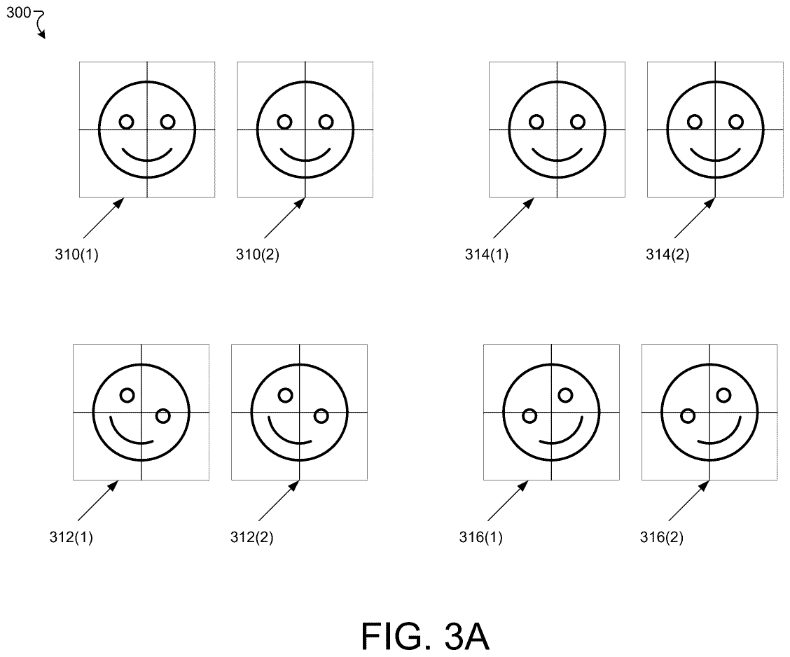

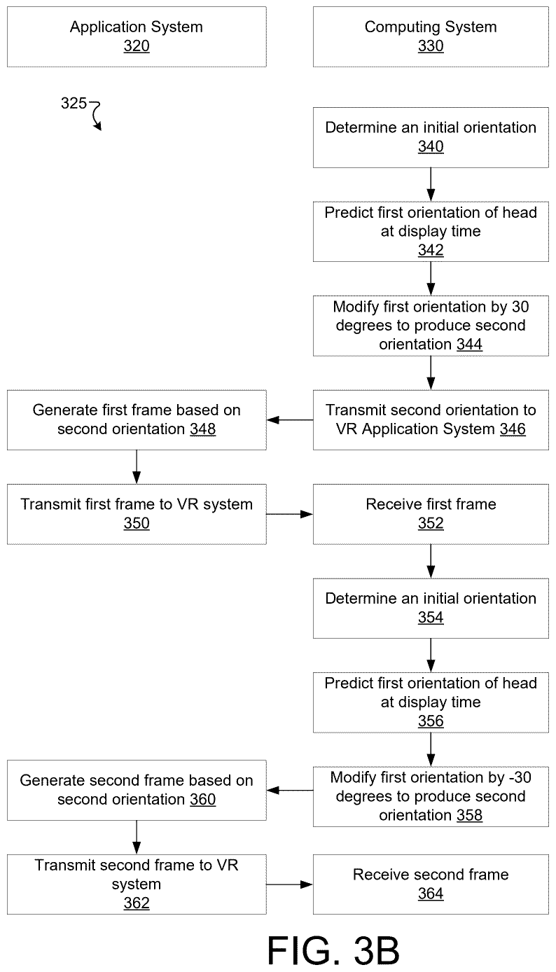

In some implementations, the modification of the orientation of the user's eyes can be an angle different from 45 degrees. For example, when a modification is performed on two successive image frames, a modification of 30 degrees for the first image frame and a modification of −30 degrees, e.g., 30 degrees in the opposite direction as in the previous frame, may be performed. When this alternating modification, +30 degrees, −30 degrees, is applied to successive frames, the artifacts can be reduced significantly. This scenario is shown with regard to FIG. 3A.

The computing system then applies an inverse rotation during composition, a late stage reprojection, and a distortion correction on the images it receives from the application system to produce the left image 216(1) and right image 216(2). The images 216(1) and 216(2) are shown with the modified, i.e., rotated coordinate system for perspective.

There can be scenarios in which no modification of the orientation of the user's eyes is performed. For example, for images that contain many diagonal or near-diagonal lines, it may be better to not perform such a modification.

In some implementations, the modification of the orientation is performed by the computing system, with the resulting modified orientation transmitted to the application system. In some implementations, however, the application system applied the modification as part of the image generation or rendering process.

FIG. 2B is a diagram illustrating an example scenario 205 involving a left image 211(1) seen by a left eye of a user and a right image 211(2) seen by a right eye of the user of an object in a head-worn device. The images 211(1) and 211(2) are shown in a non-symmetric field of view (FOV) with the object at a zero degree orientation.

As part of the image rendering process, the orientation of the user's eyes are modified so that there is an effective change in orientation of the eyes by 45 degrees so that left image 213(1) and right image 213(2) show the object at a 45 degree orientation with respect to an axis normal to the viewing plane. The user does not actually turn their head into this orientation, but rather the modified orientation is transmitted to an application server.

The computing system then applies an inverse rotation during composition, a late stage reprojection, and a distortion correction on the images it receives from the application system to produce the left image 217(1) and right image 217 (2). The images 217 (1) and 217 (2) are shown with the modified, i.e., rotated coordinate system for perspective.

There can be scenarios in which no modification of the orientation of the user's eyes is performed. For example, for images that contain many diagonal or near-diagonal lines, it may be better to not perform such a modification.

In some implementations, the modification of the orientation is performed by the computing system, with the resulting modified orientation transmitted to the application system. In some implementations, however, the application system applied the modification as part of the image generation or rendering process.

FIG. 2C is a flow chart illustrating an example process 215 of generating an image for a computing system that has a reduced artifacts due to pixelization. As shown in FIG. 2C, the process is performed by both a computing system 230 and an application system 220. The computing system is assumed here to have a symmetric FOV, but the process 215 can be performed with a non-symmetric FOV.

At 240, the computing system 230 determines an initial orientation of the user's head with respect to an axis. For example, the axis may be normal to the front of the user's body. In some implementations, the axis is normal to the viewing plane of a head-worn device. The computing system 230 may determine the initial orientation based on sensor data relayed to the processor of the computing system 230 by sensors of the computing system. In some implementations, the sensors are on the head-worn device and can include some or all of include gyroscopes, accelerometers (e.g., part of an inertial measurement unit), lidar, and the like. In some implementations, the sensors are on a wrist controller. In some implementations, sensors on the head-worn device and the wrist controller can work in concert with each other. For example, the head-worn device can include LED sources that emit pulsed light toward light sensors on the wrist controller; such a combination of emitter and detector can provide orientation of the head.

At 242, the computing system 230 predicts a first orientation of the head at the time the image is to be displayed on the computing system 230. A typical latency between determination of initial head orientation as in 240 and display of an image (as in 258) can be about 50 milliseconds, although such a latency can vary between different computing systems. In some implementations, the computing system 230 uses a model to predict the orientation of the user's head at the time of image display, e.g., 50 milliseconds in the future. For example, the computing system 230 uses a trained neural network to make the prediction of the head orientation at display time. Such a neural network would be trained on data representing users' head movements over various time intervals from initially detected orientations.

At 244, the computing system 230 modifies the first orientation—that is, the predicted orientation at display time—by 45 degrees to produce a second orientation. The computing system is not causing the user's head to turn by 45 degrees but is rather modifying the orientation data that it will transmit to the application system for rendering an image. In some implementations, the modification involves an angle different from 45 degrees, e.g., 30 degrees. The modification involves performing the 3D rotation operations involved in modifying the head orientation.

At 246, the computing system 230 transmits the second (modified) orientation to the application system 220. For example, if the application system 220 is co-located with the VR system 230, then the transmittal of the orientation may be performed within the same processor, or between a pair of connected processors. If, however, the application system 220 is located remote from the computing system 230, e.g., connected over a network, then the transmittal of data representing the orientation is performed over the network via a network interface or adaptor.

At 248, the application system 220 generates a first image of an object based on the second orientation received from the computing system 230. The application system 220 may generate the image as part of a sequence of images associated with, e.g., a film, a game, etc. The images are generated from a perspective of a virtual camera oriented at the second orientation rather than the first orientation in order that artifacts are reduced.

At 250, once the first image is generated from the perspective associated with the second orientation, the application system 220 transmits data representing the first image to the computing system 230. This transmittal occurs over the same transmittal path used at 246, e.g., over a network via a network interface. At 252, the computing system receives the data representing the first image.

At 254, the computing system 230 updates the first orientation, e.g., the orientation predicted at display time. This is to take into account any unexpected movements of the user's head during the 50 milliseconds between the determination of the initial orientation and the display of the image. The computing system 230 in this case may perform another measurement of the orientation of the user's head and compare this orientation to the first orientation.

At 256, the computing system performs a reprojection of the first image to produce a second image. The reprojection involves a rotation of the first image by 45 degrees opposite to the 45-degree rotation of the head orientation. In addition the reprojection involves a panning operation and an additional rotation based on a difference between the first orientation and the updated first orientation.

At 258, the computing system 230 displays the second image on the computing system display.

FIG. 2C is a flow chart illustrating an example process 225 of generating an image for a computing system that has a reduced artifacts. As shown in FIG. 2C, the process is performed by both a computing system 232 and the computing application system 222.

At 260, the computing system 232 determines an initial orientation of the user's head with respect to an axis. For example, the axis may be normal to the front of the user's body. In some implementations, the axis is normal to the display of a head-worn device. The computing system 232 may determine the initial orientation based on sensor data relayed to the processor of the computing system 232 by sensors of the computing system 232. In some implementations, the sensors are on the head-worn device and can include some or all of include gyroscopes, accelerometers (e.g., part of an inertial measurement unit), lidar, and the like. In some implementations, the sensors are on a wrist controller. In some implementations, sensors on the head-worn device and the wrist controller can work in concert with each other. For example, the head-worn device can include LED sources that emit pulsed light toward light sensors on the wrist controller; such a combination of emitter and detector can provide orientation of the head.

At 262, the computing system 232 predicts a first orientation of the head at the time the image is to be displayed on the computing system 232. A typical latency between determination of initial head orientation as in 240 and display of an image (as in 258) can be about 50 milliseconds, although such a latency can vary between different computing systems. In some implementations, the computing system 232 uses a model to predict the orientation of the user's head at the time of image display, e.g., 50 milliseconds in the future. For example, the computing system 232 uses a trained neural network to make the prediction of the head orientation at display time. Such a neural network would be trained on data representing users' head movements over various time intervals from initially detected orientations.

At 264, the computing system 232 transmits the first orientation to the application system 222. For example, if the application system 222 is co-located with the computing system 232, then the transmittal of the orientation may be performed within the same processor, or between a pair of connected processors. If, however, the application system 222 is located remote from the computing system 232, e.g., connected over a network, then the transmittal of data representing the orientation is performed over the network via a network interface or adaptor.

At 266, the application system 222 modifies the first orientation—that is, the predicted orientation at display time—by 45 degrees to produce a second orientation. The VR system is not causing the user's head to turn by 45 degrees but is rather modifying the orientation data for rendering an image. In some implementations, the modification involves an angle different from 45 degrees, e.g., 30 degrees. The modification involves performing the 3D rotation operations involved in modifying the head orientation.

At 268, the application system 222 generates a first image of an object based on the second orientation received from the computing system 232. The application system 222 may generate the image as part of a sequence of images associated with, e.g., a film, a game, etc. The images are generated from a perspective of a virtual camera oriented at the second orientation rather than the first orientation in order that artifacts are reduced.

At 270, once the first image is generated from the perspective associated with the second orientation, the application system 222 transmits data representing the first image to the computing system 232. This transmittal occurs over the same transmittal path used at 246, e.g., over a network via a network interface. At 272, the computing system 232 receives the data representing the first image.

At 274, the computing system 232 updates the first orientation, e.g., the orientation predicted at display time. This is to take into account any unexpected movements of the user's head during the 50 milliseconds between the determination of the initial orientation and the display of the image. The computing system 232 in this case may perform another measurement of the orientation of the user's head and compare this orientation to the first orientation.

At 276, the computing system 232 performs a reprojection of the first image to produce a second image. The reprojection involves a rotation of the first image by 45 degrees opposite to the 45-degree rotation of the head orientation. In addition the reprojection involves a panning operation and an additional rotation based on a difference between the first orientation and the updated first orientation.

At 278, the computing system 232 displays the second image on the computing system 232 display.

FIG. 3A is a diagram illustrating an example scenario 300 involving a first left image frame 310(1) seen by a left eye of a user and a first right image frame 310(2) seen by a right eye of the user of an object in a head-worn device. In contrast to the scenario 200 in FIG. 2B, the scenario 300 involves multiple image frames. The image frames 310(1) and 310(2) are shown in a symmetric field of view (FOV) with the object at a zero degree orientation. The scenario 300 may involve non-symmetric FOV s in some implementations.

As part of the image rendering process, the orientation of the user's eyes are modified so that there is an effective change in orientation of the eyes by 30 degrees so that first left image frame 212(1) and first right image frame 212(2) show the object at a 30 degree orientation with respect to an axis normal to the viewing plane. The user does not actually turn their head into this orientation, but rather the modified orientation is transmitted to an application server. In some implementations, the application system renders to a larger field of view to account for non-symmetric fields of view.

For a second image frame, the orientation of the images are modified in a direction opposite that for the first image frame. Thus, second left image frame 314(1) seen by a left eye of a user and a second right image frame 314(2) seen by a right eye of the user of an object in a head-worn device are shown to be in roughly the same orientation as first image frames 310(1) and 310(2). Nevertheless, as shown in FIG. 3A, as part of the image rendering process, the orientation of the user's eyes are modified so that there is an effective change in orientation of the eyes by −30 degrees so that second left image frame 216(1) and second right image frame 216(2) show the object at a −30 degree orientation with respect to an axis normal to the viewing plane; that is, 30 degrees in a direction opposite that used in first image frames 310(1) and 310(2). The benefit of this alternating frame orientation is that it is an effective artifact reduction scheme.

There can be scenarios in which no modifications of the orientation of the user's head is performed. For example, for images that contain many diagonal or near-diagonal lines, it may be better to not perform such a modification.

In some implementations, the modifications of the orientation is performed by the computing system, with the resulting modified orientation transmitted to the application system. In some implementations, however, the application system applied the modification as part of the image generation or rendering process.

FIG. 3B is a diagram illustrating an example process 325 of generating image frames for a computing system that have reduced artifacts. As shown in FIG. 3B, the process is performed by both a computing system 330 and a application system 320.

At 340, the computing system 330 determines an initial orientation of the user's head with respect to an axis. For example, the axis may be normal to the front of the user's body. In some implementations, the axis is normal to the display of a head-worn device. The computing system 330 may determine the initial orientation based on sensor data relayed to the processor of the computing system 330 by sensors of the computing system 330. In some implementations, the sensors are on the head-worn device and can include some or all of include gyroscopes, accelerometers (e.g., part of an inertial measurement unit), lidar, and the like. In some implementations, the sensors are on a wrist controller. In some implementations, sensors on the head-worn device and the wrist controller can work in concert with each other. For example, the head-worn device can include LED sources that emit pulsed light toward light sensors on the wrist controller; such a combination of emitter and detector can provide orientation of the head.

At 342, the computing system 330 predicts a first orientation of the head at the time the image is to be displayed on the computing system 330. A typical latency between determination of initial head orientation as in 340 and display of an image can be about 50 milliseconds, although such a latency can vary between different VR systems. In some implementations, the computing system 330 uses a model to predict the orientation of the user's head at the time of image display, e.g., 50 milliseconds in the future. For example, the computing system 330 uses a trained neural network to make the prediction of the head orientation at display time. Such a neural network would be trained on data representing users' head movements over various time intervals from initially detected orientations.

At 344, the computing system modifies the first orientation—that is, the predicted orientation at display time—by 30 degrees to produce a second orientation. The computing system is not causing the user's head to turn by 30 degrees but is rather modifying the orientation data that it will transmit to the application system for rendering an image. In some implementations, the modification involves an angle different from 30 degrees, e.g., 20 degrees. The modification involves performing the 3D rotation operations involved in modifying the head orientation.

At 346, the computing system 330 transmits the second (modified) orientation to the application system 320. For example, if the application system 320 is co-located with the computing system 330, then the transmittal of the orientation may be performed within the same processor, or between a pair of connected processors. If, however, the application system 320 is located remote from the computing system 330, e.g., connected over a network, then the transmittal of data representing the orientation is performed over the network via a network interface or adaptor.

At 348, the application system 320 generates a first image frame based on the second orientation received from the computing system 330. The application system 320 may generate the image as part of a sequence of images associated with, e.g., a film, a game, etc. The images are generated from a perspective of a virtual camera oriented at the second orientation rather than the first orientation in order that artifacts are reduced.

At 350, once the first image frame is generated from the perspective associated with the second orientation, the application system 320 transmits data representing the first image frame to the computing system 330. This transmittal occurs over the same transmittal path used at 346, e.g., over a network via a network interface. At 352, the computing system 330 receives the data representing the first image frame.

At 354, the computing system 330 determines an initial orientation of the user's head with respect to the axis, but this time for a second image frame. For example, the axis may be normal to the front of the user's body. In some implementations, the axis is normal to the display of the head-worn device. The computing system 330 may determine the initial orientation based on sensor data relayed to the processor of the computing system 330 by sensors of the computing system 330. In some implementations, the sensors are on the head-worn device and can include some or all of include gyroscopes, accelerometers (e.g., part of an inertial measurement unit), lidar, and the like. In some implementations, the sensors are on a wrist controller. In some implementations, sensors on the head-worn device and the wrist controller can work in concert with each other. For example, the head-worn device can include LED sources that emit pulsed light toward light sensors on the wrist controller; such a combination of emitter and detector can provide orientation of the head.

At 356, the computing system 330 predicts a first orientation of the head at the time the image is to be displayed on the computing system 330. A typical latency between determination of initial head orientation as in 340 and display of an image can be about 50 milliseconds, although such a latency can vary between different computing systems. In some implementations, the computing system 330 uses a model to predict the orientation of the user's head at the time of image display, e.g., 50 milliseconds in the future. For example, the computing system 330 uses a trained neural network to make the prediction of the head orientation at display time. Such a neural network would be trained on data representing users' head movements over various time intervals from initially detected orientations.

At 358, the computing system 330 modifies the first orientation—that is, the predicted orientation at display time—by −30 degrees to produce a second orientation—that is, 30 degrees opposite to that for the previous frame. The computing system 330 is not causing the user's head to turn by −30 degrees but is rather modifying the orientation data that it will transmit to the application system 320 for rendering an image. In some implementations, the modification involves an angle different from −30 degrees, e.g., −20 degrees, but generally should be the same change in orientation but in the opposite direction. The modification involves performing the 3D rotation operations involved in modifying the head orientation.

At 360, the computing system 330 transmits the second (modified) orientation to the application system 320. For example, if the application system 320 is co-located with the computing system 330, then the transmittal of the orientation may be performed within the same processor, or between a pair of connected processors. If, however, the application system 320 is located remote from the computing system 330, e.g., connected over a network, then the transmittal of data representing the orientation is performed over the network via a network interface or adaptor.

At 362, the application system 320 generates a second image frame based on the second orientation received from the computing system 330. The application system 320 may generate the image as part of a sequence of images associated with, e.g., a film, a game, etc. The images are generated from a perspective of a virtual camera oriented at the second orientation rather than the first orientation in order that artifacts are reduced.

At 364, once the second image frame is generated from the perspective associated with the second orientation, the application system 320 transmits data representing the second image frame to the computing system 330. This transmittal occurs over the same transmittal path used at 346, e.g., over a network via a network interface. At 352, the computing system 330 receives the data representing the second image frame.

The first and second images frames are then reprojected and displayed as in FIG. 2C. Note that, in some implementations, this alternating frames process 325 of reducing aliasing artifacts may also be performed analogously with the process 225 in FIG. 2D, with the application system 320 modifying the head orientations.

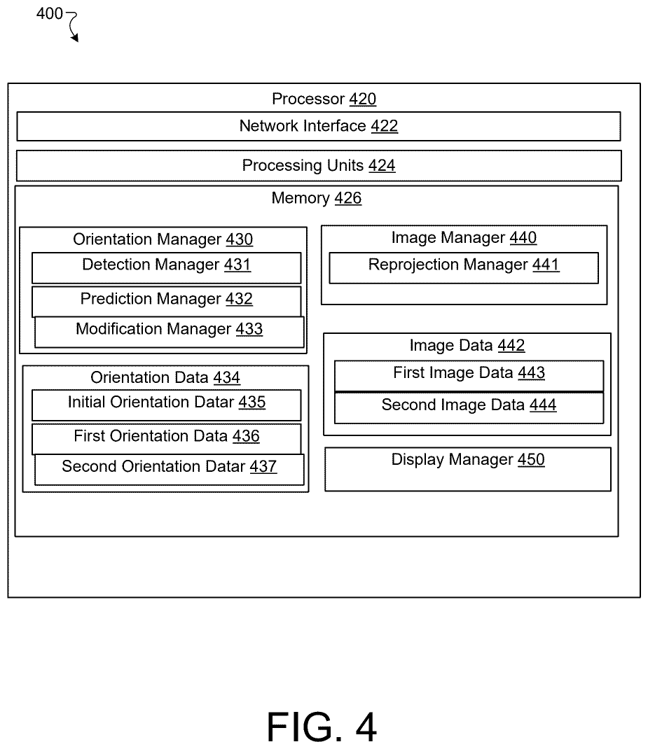

FIG. 4 is a diagram illustrating an example electronic environment in which the above-described reduction of artifacts in computing device images may be performed. As shown in FIG. 4, the electronic environment includes the processor 420 of the computing system 230.

The processor 420 includes a network interface 422, one or more processing units 424, and the (nontransitory) memory 426. The network interface 422 includes, for example, Ethernet adaptors, Bluetooth adaptors, and the like, for converting electronic and/or optical signals received from the network to electronic form for use by the processor 420. The set of processing units 424 include one or more processing chips and/or assemblies. The memory 426 is a storage medium and includes both volatile memory (e.g., RAM) and non-volatile memory, such as one or more read only memories (ROM s), disk drives, solid state drives, and the like. The set of processing units 424 and the memory 426 together form part of the processor 420, which is configured to perform various methods and functions as described herein as a computer program product.

In some implementations, one or more of the components of the processor 420 can be, or can include processors (e.g., processing units 424) configured to process instructions stored in the memory 426. Examples of such instructions as depicted in FIG. 4 include an orientation manager 430, an image manager 440, and a display manager 450. Further, as illustrated in FIG. 4, the memory 426 is configured to store various data, which is described with respect to the respective managers that use such data.

The orientation manager 430 is configured to determine, as orientation data 434, an orientation of the user's head that will be used for both generation of image frames by the application system as well as for reprojection of the image prior to display. As shown in FIG. 4, the orientation manager 430 includes a detection manager 431, a prediction manager 432, and a modification manager 433.

The detection manager 431 is configured to cause various sensors of the computing system to detect, as initial orientation data 435, an initial orientation of the user's head with respect to an axis. For example, the axis may be normal to the front of the user's body. In some implementations, the axis is normal to the display of a head-worn device, e.g., 210(1). The detection manager is configured to determine the initial orientation based on sensor data relayed to the processor 420 by the sensors. In some implementations, the sensors are on the head-worn device and can include some or all of include gyroscopes, accelerometers (e.g., part of an inertial measurement unit), lidar, and the like. In some implementations, the sensors are on a wrist controller. In some implementations, sensors on the head-worn device and the wrist controller can work in concert with each other. For example, the head-worn device can include LED sources that emit pulsed light toward light sensors on the wrist controller; such a combination of emitter and detector can provide orientation of the head.

The prediction manager 432 is configured to predict, as first orientation data 436, a first orientation of the head at the time the image is to be displayed on the computing system. A typical latency between determination of initial head orientation and display of an image can be about 50 milliseconds, although such a latency can vary between different computing systems. In some implementations, the prediction manager 432 uses a model to predict the orientation of the user's head at the time of image display, e.g., 50 milliseconds in the future. For example, the prediction manager 432 uses a trained neural network to make the prediction of the head orientation at display time. Such a neural network would be trained on data representing users' head movements over various time intervals from initially detected orientations.

The modification manager 433 is configured to modify the first orientation—that is, the predicted orientation at display time—by 45 degrees to produce, as the second orientation data 437, a second orientation. The modification manager 433 is not causing the user's head to turn by 45 degrees but is rather modifying the orientation data that it will transmit to the application system for rendering an image. In some implementations, the modification involves an angle different from 45 degrees, e.g., 30 degrees. The modification involves performing the 3D rotation operations involved in modifying the head orientation.

The image manager 440 is configured to receive, as first image data 443 of image data 442, an image generated by the application system based on the second orientation. As shown in FIG. 4, the image manager 440 include a reprojection manager 441.

The reprojection manager 441 is configured to perform a late stage reprojection of the first image represented by the first image data 443 to produce a second image represented by second image data 444. This late stage reprojection is an additional rendering stage that addresses any possible unexpected head motion that may cause the orientation at display time to be different from the predicted orientation. Accordingly, after receiving the image of the object from the application system, the reprojection manager 441 updates the head orientation after receiving the image; at this point, there are about 5 milliseconds remaining until the image is displayed and further head movements will not be significant. The reprojection manager 441 then reprojects the image, e.g., the reprojection manager 441 pans and rotates the image to correct for any differences between the predicted orientation sent to the application system and the updated orientation.

The display manager 650 is configured to display the second image represented by second image data 444 on a display. In some implementations, the display is a stereoscopic display with images for the left eye and the right eye of the user. In some implementations, the display has a first portion (e.g., left) and a second portion (e.g., right). In some implementations, the display manager 650 is configured to rotate, e.g., the second portion of the display with respect to the first portion. In some implementations, the first portion is rotated with respect to the second portion. A benefit of such a rotation is a further reduction of artifacts in the displayed image.

The components (e.g., modules, processing units 424) of processor 420 can be configured to operate based on one or more platforms (e.g., one or more similar or different platforms) that can include one or more types of hardware, software, firmware, operating systems, runtime libraries, and/or so forth. In some implementations, the components of the processor 420 can be configured to operate within a cluster of devices (e.g., a server farm). In such an implementation, the functionality and processing of the components of the processor 420 can be distributed to several devices of the cluster of devices.

The components of the processor 420 can be, or can include, any type of hardware and/or software configured to process attributes. In some implementations, one or more portions of the components shown in the components of the processor 420 in FIG. 4 can be, or can include, a hardware-based module (e.g., a digital signal processor (DSP), a field programmable gate array (FPGA), a memory), a firmware module, and/or a software-based module (e.g., a module of computer code, a set of computer-readable instructions that can be executed at a computer). For example, in some implementations, one or more portions of the components of the processor 420 can be, or can include, a software module configured for execution by at least one processor (not shown). In some implementations, the functionality of the components can be included in different modules and/or different components than those shown in FIG. 4, including combining functionality illustrated as two components into a single component.

Although not shown, in some implementations, the components of the processor 420 (or portions thereof) can be configured to operate within, for example, a data center (e.g., a cloud computing environment), a computer system, one or more server/host devices, and/or so forth. In some implementations, the components of the processor 420 (or portions thereof) can be configured to operate within a network. Thus, the components of the processor 420 (or portions thereof) can be configured to function within various types of network environments that can include one or more devices and/or one or more server devices. For example, the network can be, or can include, a local area network (LAN), a wide area network (WAN), and/or so forth. The network can be, or can include, a wireless network and/or wireless network implemented using, for example, gateway devices, bridges, switches, and/or so forth. The network can include one or more segments and/or can have portions based on various protocols such as Internet Protocol (IP) and/or a proprietary protocol. The network can include at least a portion of the Internet.

In some implementations, one or more of the components of the search system can be, or can include, processors configured to process instructions stored in a memory. For example, orientation manager 630 (and/or a portion thereof), image manager 640 (and/or a portion thereof), and display manager 650 (and/or a portion thereof) are examples of such instructions.

In some implementations, the memory 426 can be any type of memory such as a random-access memory, a disk drive memory, flash memory, and/or so forth. In some implementations, the memory 426 can be implemented as more than one memory component (e.g., more than one RAM component or disk drive memory) associated with the components of the processor 420. In some implementations, the memory 426 can be a database memory. In some implementations, the memory 426 can be, or can include, a non-local memory. For example, the memory 426 can be, or can include, a memory shared by multiple devices (not shown). In some implementations, the memory 426 can be associated with a server device (not shown) within a network and configured to serve the components of the processor 420. As illustrated in FIG. 4, the memory 4126 is configured to store various data, including orientation data 434 and image data 442.

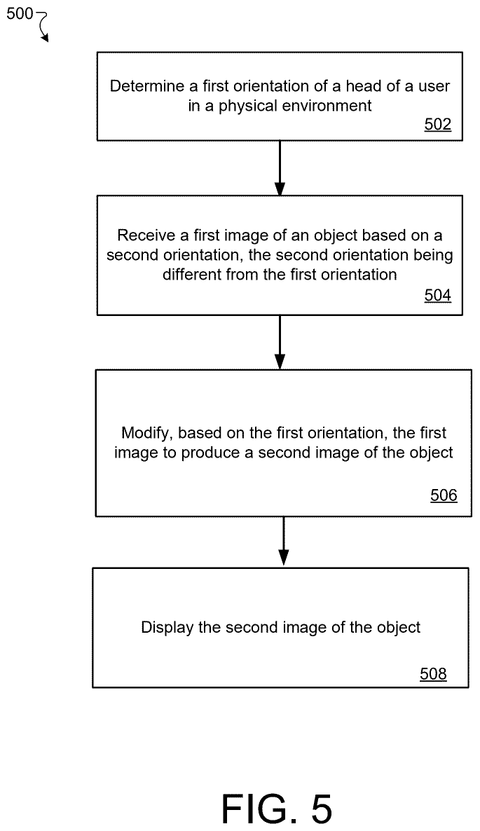

FIG. 5 is a flow chart illustrating an example process 500 of reducing artifacts in computing system images. The process 500 may be carried out on a processor and memory such as processor 420 and memory 426 of FIG. 4.

At 502, an orientation manager, e.g., orientation manager 430 determines a first orientation (e.g., 212(1)) of a head (e.g., 210(1)) of a user in a physical environment.

At 504, an image manager, e.g., image manager 440 receives a first image of an object (e.g., at 252) based on a second orientation (e.g., 212(2)), the second orientation being different from the first orientation.

At 506, the image manager modifies, based on the first orientation, the first image to produce a second image of the object (e.g., at 256).

At 508, a display manager, e.g., display manager 450 displays the second image of the object.

Example 1. A method, comprising: determining a first orientation of a head of a user in a physical environment; receiving a first image of an object based on a second orientation, the second orientation being different from the first orientation; modifying, based on the first orientation, the first image to produce a second image of the object; and displaying the second image of the object.

Example 2. The method as in example 1, wherein modifying the first image includes performing a rotation operation on the first image.

Example 3. The method as in example 2, wherein the rotation operation represents a rotation about an axis normal to a display on which the second image of the object is displayed.

Example 4. The method as in example 2, wherein the rotation operation represents a rotation such that an orientation on which the second image of the object is based is different from the first orientation by a predetermined amount.

Example 5. The method as in example 4, wherein the predetermined amount is based on a prediction of a movement of the head of the user in a time interval between receiving the first image of the object and producing the second image of the object.

Example 6. The method as in example 1, further comprising: generating the second orientation based on the first orientation.

Example 7. The method as in example 6, wherein the second orientation differs from the first orientation by about 45 degrees.

Example 8. The method as in example 1, wherein the first image of the object and the second image of the object belong to a first frame of a sequence of frames; wherein the method further comprises: receiving a first image of a second frame of the sequence of frames, the first image of the second frame being based on a third orientation, the third orientation being an opposite of the second orientation; and modifying, based on the first orientation, the first image of the second frame to produce a second image of the second frame.

Example 9. The method as in example 8, wherein the second orientation differs from the first orientation by about 30 degrees.

Example 10. The method as in example 1, wherein determining the first orientation includes detecting an initial orientation of the head of the user in the physical environment; and generating the first orientation as a prediction of an orientation of the head of the user at a time when the second image of the object is displayed.

Example 11. The method as in example 1, wherein the method is performed by a computing system configured to generate a virtual environment in which the second image of the object is displayed.

Example 12. The method as in example 11, further comprising transmitting data representing the first orientation to an application system configured to generate the first image of the object based on the second orientation.

Example 13. The method as in example 11, further comprising generating the second orientation by modifying the first orientation; and transmitting data representing the second orientation to an application system configured to generate the first image of the object based on the second orientation.

Example 14. The method as in example 1, wherein a display on which the second image is displayed has a first portion and a second portion; and wherein the method further comprises: rotating the second portion of the display with respect to the first portion of the display.

Example 15. An apparatus, comprising: memory; and a processor coupled to the memory, the processor being configured to: determine a first orientation of a head of a user in a physical environment; receive a first image of an object based on a second orientation, the second orientation being different from the first orientation; modify, based on the first orientation, the first image to produce a second image of the object; and display the second image of the object.

Example 16. The apparatus as in example 15, wherein the processor is further configured to: generate the second orientation based on the first orientation.

Example 17. The apparatus as in example 16, wherein the second orientation differs from the first orientation by about 45 degrees.

Example 18. A computer program product comprising a nontransitory storage medium, the computer program product including code that, when executed by processing circuitry, causes the processing circuitry to perform a method, the method comprising: determining a first orientation of a head of a user in a physical environment; receiving a first image of an object based on a second orientation, the second orientation being different from the first orientation; modifying, based on the first orientation, the first image to produce a second image of the object; and displaying the second image of the object.

Example 19. The computer program product as in example 18, wherein modifying the first image includes: performing a rotation operation on the first image.

Example 20. The computer program product as in example 19, wherein the rotation operation represents a rotation about an axis normal to a display on which the second image of the object is displayed.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitely indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method, comprising:
determining a first orientation of a head of a user in a physical environment;
receiving a first image of an object based on a second orientation, the second orientation being different from the first orientation;
modifying, based on the first orientation, the first image to produce a second image of the object; and
displaying the second image of the object.

2. The method as in claim 1, wherein modifying the first image includes:
performing a rotation operation on the first image.

3. The method as in claim 2, wherein the rotation operation represents a rotation about an axis normal to a display on which the second image of the object is displayed.

4. The method as in claim 2, wherein the rotation operation represents a rotation such that an orientation on which the second image of the object is based is different from the first orientation by a predetermined amount.

5. The method as in claim 4, wherein the predetermined amount is based on a measurement of a movement of the head of the user in a time interval between receiving the first image of the object and producing the second image of the object.

6. The method as in claim 1, further comprising:
generating the second orientation based on the first orientation.

7. The method as in claim 6, wherein the second orientation differs from the first orientation by about 45 degrees.

8. The method as in claim 1, wherein the first image of the object and the second image of the object belong to a first frame of a sequence of frames;
wherein the method further comprises:
receiving a first image of a second frame of the sequence of frames, the first image of the second frame being based on a third orientation, the third orientation being an opposite of the second orientation; and
modifying, based on the first orientation, the first image of the second frame to produce a second image of the second frame.

9. The method as in claim 8, wherein the second orientation differs from the first orientation by about 30 degrees.

10. The method as in claim 1, wherein determining the first orientation includes:
detecting an initial orientation of the head of the user in the physical environment; and
generating the first orientation as a prediction of an orientation of the head of the user at a time when the second image of the object is displayed.

11. The method as in claim 1, wherein the method is performed by a computing system configured to generate a virtual environment in which the second image of the object is displayed.

12. The method as in claim 11, further comprising:
transmitting data representing the first orientation to an application system configured to generate the first image of the object based on the second orientation.

13. The method as in claim 11, further comprising:
generating the second orientation by modifying the first orientation; and
transmitting data representing the second orientation to an application system configured to generate the first image of the object based on the second orientation.

14. The method as in claim 1, wherein a display on which the second image is displayed has a first portion and a second portion; and
wherein the method further comprises:
rotating the second portion of the display with respect to the first portion of the display.

15. An apparatus, comprising:
memory; and
a processor coupled to the memory, the processor being configured to:
determine a first orientation of a head of a user in a physical environment;
receive a first image of an object based on a second orientation, the second orientation being different from the first orientation;
modify, based on the first orientation, the first image to produce a second image of the object; and
display the second image of the object.

16. The apparatus as in claim 15, wherein the processor is further configured to:
generate the second orientation based on the first orientation.

17. The apparatus as in claim 16, wherein the second orientation differs from the first orientation by about 45 degrees.

18. A computer program product comprising a nontransitory storage medium, the computer program product including code that, when executed by processing circuitry, causes the processing circuitry to perform a method, the method comprising:
determining a first orientation of a head of a user in a physical environment;
receiving a first image of an object based on a second orientation, the second orientation being different from the first orientation;
modifying, based on the first orientation, the first image to produce a second image of the object; and
displaying the second image of the object.

19. The computer program product as in claim 18, wherein modifying the first image includes:
performing a rotation operation on the first image.

20. The computer program product as in claim 19, wherein the rotation operation represents a rotation about an axis normal to a display on which the second image of the object is displayed.
